(19) United States
(12) Patent Application Publication
(10) Pub. No.: US 2011/0130175 A1
(43) Pub. Date: Jun. 2, 2011

(54) CORDLESS TELEPHONE HANDSET HAVING A WIDE PASSBAND ELECTROACOUSTIC CHAIN

(76) Inventor: Gilles Bourgoin, Rueil-Malmaison (FR)

(21) Appl. No.: 13/057,246

(22) PCT Filed: Jul. 30, 2009
(86) PCT No.: PCT/FR2009/000954

§ 371 Date: Feb. 2, 2011

(30) Foreign Application Priority Data
Aug. 4, 2008 (FR) 08 04423

(51) Int. Cl. H04W 88/02

(52) U.S. Cl. 455/569.1

(57) ABSTRACT

A wireless telephone handset includes a processing unit having associated therewith a microphone, an earpiece, and a loudspeaker mounted on a wall of an enclosure provided with a vent having dimensions adapted to co-operate with the enclosure to form a Helmholtz resonator.

The present invention relates to a wireless telephone handset including an electroacoustic system having a wide passband.

### BACKGROUND OF THE INVENTION

It is known that wireless telephone handsets, whether used in local networks (at home) or in extended networks (GSM), are generally of small dimensions in order to be capable of being kept in a user's pocket. Consequently, the loudspeakers with which such telephone handsets are being fitted ever more frequently, and in particular the loudspeakers making hands-free use possible, are themselves of small dimensions. This results in such loudspeakers presenting limited performance, in particular concerning their passband.

In particular from document EP-A-0 843 452, a telephone handset is known that is provided with a piezoelectric loudspeaker associated with Helmholtz resonators for improving playback of high frequencies.

In particular from document GB 2 333 004, a telephone handset is also known that includes a loudspeaker having a cavity provided in front of it that forms a Helmholtz resonator for filtering a medium frequency band.

### OBJECT OF THE INVENTION

An object of the invention is to provide a wireless telephone handset having a passband that is improved compared with existing handsets.

### SUMMARY OF THE INVENTION

In order to achieve this object, the invention proposes a wireless telephone handset comprising a housing enclosing an acoustic processing unit associated with a microphone and an electromagnetic loudspeaker, the loudspeaker being mounted on a wall of an enclosure that extends behind the loudspeaker and that includes at least one vent having dimensions adapted to co-operate with the enclosure to form a Helmholtz resonator.

Thus, the acoustic response of the loudspeaker is improved in the low frequency range so that the passband of the acoustic system is made wider.

In a preferred embodiment, said at least one vent opens out into a compartment for receiving an electrical power supply battery of the handset.

This takes advantage of the volume left empty by the battery so as to benefit from the resonator effect. This makes it possible to avoid the vent opening out directly to the outside with consequences concerning appearance and risks of the vent becoming blocked by the user's hand or by accumulated dirt.

### BRIEF DESCRIPTION OF THE DRAWINGS

Other characteristics and advantages of the invention appear on reading the following description of a particular and non-limiting embodiment of the invention given with reference to the accompanying figures, in which:

FIG. 1 is a partially cutaway perspective view of a telephone handset in accordance with a general principle of the invention;

FIG. 2 is a diagrammatic representation of the acoustic system of the telephone handset of the invention; and

FIG. 3 is a perspective view from the back of a telephone handset in a preferred embodiment of the invention.

### DETAILED DESCRIPTION OF THE INVENTION

With reference to FIG. 2, the telephone handset comprises a housing 18 containing a conventional acoustic processing unit 1, associated with a microphone 2, an earpiece 3 connected to an amplifier member 4, and a loudspeaker 5 electromagnetically connected to an amplifier member 6. Also in conventional manner, the loudspeaker 5 is mounted on a wall of an enclosure 7 in such a manner that the enclosure 7 is behind the loudspeaker 5. The handset also includes a housing element 8 spaced apart from the enclosure 7 and defining an intermediate space 9. Facing the loudspeaker 5, the housing element 8 includes openings 10.

The enclosure 7 is fitted with a vent 11 having dimensions adapted to co-operate with the enclosure 7 to form a Helmholtz resonator that is tuned to the volume of the enclosure 7.

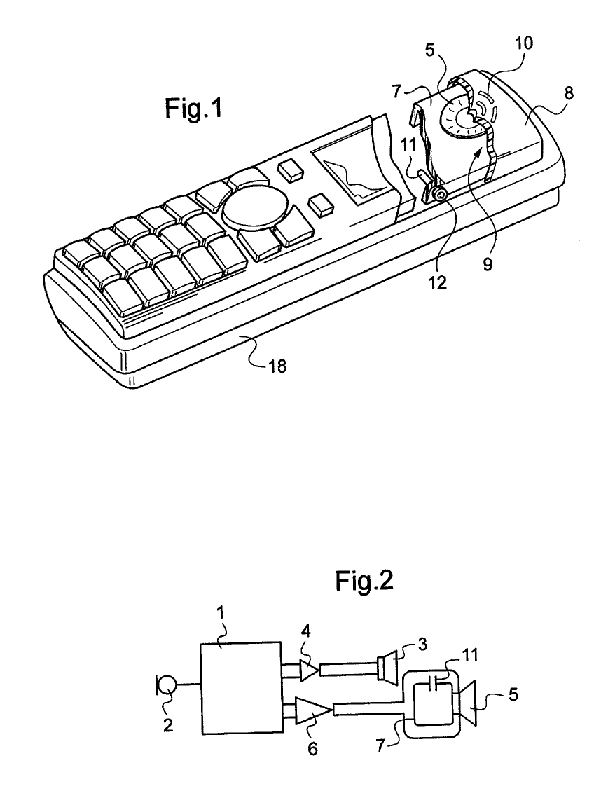

Preferably, as shown in FIG. 1, the vent 11 has an outlet orifice 12 that opens to the intermediate volume 9, being offset relative to the openings 10 of the housing element. This arrangement serves to avoid dust penetrating into the enclosure 7 by passing through the vent 11.

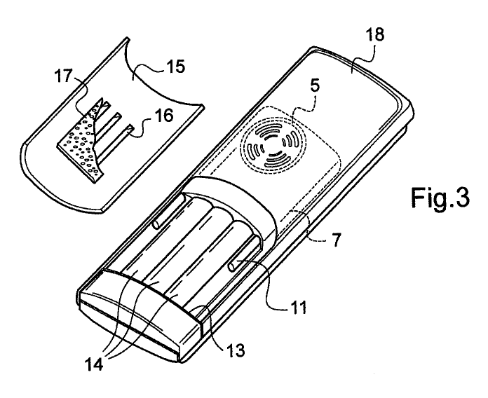

In the preferred embodiment, as shown in FIG. 3 and as described above, the electromagnetic loudspeaker 5 that opens out into the back of the handset is fastened to a wall of an enclosure 7 that is located behind the loudspeaker 5. This enclosure 7 has two vents 11 of dimensions adapted to co-operate with the enclosure 7 behind the loudspeaker 5 to form a Helmholtz resonator tuned to the volume of the enclosure 7. These vents 11 include an outlet orifice 12 opening out into a compartment 13 that receives the electrical power supply batteries 14 of the handset. The compartment 13 is closed by a lid 15 provided with openings 16 that are offset relative to the outlet orifice 12. A piece of felt 17 (partially cut away in FIG. 3 to uncover the openings 16), serves to pass air and extends over the openings 16 inside the compartment 13 in order to prevent dirt penetrating into the compartment 13, but without degrading acoustic performance.

Naturally, the invention is not limited to the embodiment described and may be subjected to variants that appear to the person skilled in the art without going beyond the ambit of the invention as defined by the claims.

In particular, the handset may have a single vent passing through the wall of the enclosure, or a plurality of vents so that their dimensions are better adapted to the dimensions of the enclosure 7 and optionally to the dimensions of the compartment 13, so that the resulting resonator remains tuned to the inside volume of the enclosure 7.

When the vent opens out in the proximity of the openings facing the loudspeaker, a fine piece of felt may be provided that allows air to pass while filtering impurities, but without degrading the acoustic performance of the loudspeaker.

Furthermore, in order to make the handset more compact while conserving its acoustic performance, provision may be made to mount the earpiece 3 in front of the loudspeaker 5 and to connect the earpiece 3 to the amplifier member 6 of the loudspeaker 5 via a highpass filter.

Given the performance of the loudspeaker of the invention, it is also possible to make provision for omitting the earpiece, with individual listening then taking place via the loudspeaker powered by a signal at low level.

What is claimed is:

1. A wireless telephone handset comprising a housing enclosing an acoustic processing unit associated with a microphone and an electromagnetic loudspeaker, wherein the loudspeaker is mounted on a wall of an enclosure that extends behind the loudspeaker and that includes at least one vent having dimensions adapted to co-operate with the enclosure to form a Helmholtz resonator, and wherein said at least one vent opens out into a compartment for receiving an electrical power supply battery of the handset.

2. The telephone handset according to claim 1, wherein the compartment is closed by a cover provided with at least one opening that is offset relative to an outlet orifice of said at least one vent.

3. The telephone handset according to claim 2, wherein a felt is placed between the vent and the opening.

4. The telephone handset according to claim 2, wherein means for allowing air to pass while filtering impurities is mounted between the vent and the opening.

5. A housing enclosing an acoustic processing unit associated with an electromagnetic loudspeaker, wherein the loudspeaker is mounted on a wall of an enclosure that extends behind the loudspeaker and that includes at least one vent having dimensions adapted to co-operate with the enclosure to form a Helmholtz resonator, and wherein said at least one vent opens out into a compartment for receiving an electrical power supply battery of the handset.

6. The housing according to claim 5, wherein the compartment is closed by a cover provided with at least one opening that is offset relative to an outlet orifice of said at least one vent.

7. A housing according to claim 5, wherein a felt is placed between the vent and the opening.

8. The housing according to claim 5, wherein means for allowing air to pass while filtering impurities is disposed between the vent and the opening.

9. A housing according to claim 5, wherein a microphone is associated with the acoustic processing unit.
